(19) United States
(12) Patent Application Publication
(10) Pub. No.: US 2007/0276744 A1
(43) Pub. Date: Nov. 29, 2007

(54) SYSTEMS AND METHODS FOR FACILITATING COMPLETION OF REPURCHASE AGREEMENTS

(76) Inventor: Joseph R. Burke, Wilton, CT (US)

Correspondence Address: DEAN P. ALDERUCCI, CANTOR FITZGERALD, L.P., 110 EAST 59TH STREET (6TH FLOOR), NEW YORK, NY, 10022, US

(21) Appl. No.: 11/626,962

(22) Filed: Jan. 25, 2007

Related U.S. Application Data
(60) Provisional application No. 60/762,409, filed on Jan. 25, 2006.
(60) Provisional application No. 60/839,599, filed on Aug. 23, 2006.

(51) Int. Cl. G06Q 40/00

(52) U.S. Cl. 705/35

(57) ABSTRACT

Methods and corresponding system are provided herewith that, in at least one embodiment, include the step or steps of receiving at least one order for a repurchase agreement involving an asset, determining in response to the at least one order an existence of at least one of the asset and money to satisfy at least a purchase portion of the repurchase agreement, and communicating a notification of the existence of the at least one of the asset and money.

The present application claims priority to U.S. Provisional Patent Application Nos. 60/762,409, filed Jan. 25, 2006, and 60/839,599, filed Aug. 23, 2006, which are hereby incorporated herein by reference. The present application may further relate to U.S. patent application Ser. No. 10/127,226, filed Apr. 19, 2002, which is hereby incorporated herein by reference for the purpose of enablement and written description.

### BRIEF DESCRIPTION OF THE FIGURES

FIG. 1 illustrates a system according to at least one embodiment of the systems disclosed herein;

FIG. 2 illustrates a flowchart of a method according to at least one embodiment of the system and methods disclosed herein; and

FIGS. 3-4 illustrate interface screens for use in at least one of the methods and systems disclosed herein.

### DESCRIPTION OF THE INVENTION

The following sections I-X provide a guide to interpreting the present application.

I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

IV. Disclosed Examples and Terminology are Not Limiting

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. § 1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

All words in every claim have the broadest scope of meaning they would have been given by a person of ordinary skill in the art as of the priority date. No term used in any claim is specially defined or limited by this application except where expressly so stated either in this specification or in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

V. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., a computer program.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

VI. Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

VII. 35 U.S.C. § 112, Paragraph 6

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function hat is a method, one structure for performing this method includes a computing device (e.g., a general purpose computer) that is programmed and/or configured with appropriate hardware to perform that function.

Also includes a computing device (e.g., a general purpose computer) that is programmed and/or configured with appropriate hardware to perform that function via other algorithms as would be understood by one of ordinary skill in the art.

VIII. Disclaimer

Numerous references to a particular embodiment does not indicate a disclaimer or disavowal of additional, different embodiments, and similarly references to the description of embodiments which all include a particular feature does not indicate a disclaimer or disavowal of embodiments which do not include that particular feature. A clear disclaimer or disavowal in the present application shall be prefaced by the phrase “does not include” or by the phrase “cannot perform”.

IX. Incorporation by Reference

Any patent, patent application or other document referred to herein is incorporated by reference into this patent application as part of the present disclosure, but only for purposes of written description in accordance with 35 U.S.C. § 112, paragraph 1 and enablement in accordance with 35 U.S.C. § 112, paragraph 1, and should in no way be used to limit, define, or otherwise construe any term of the present application where the present application, without such incorporation by reference, would not have failed to provide an ascertainable meaning, but rather would have allowed an ascertainable meaning for such term to be provided. Thus, the person of ordinary skill in the art need not have been in any way limited by any embodiments provided in the reference.

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

X. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

XI. Overview of Various Embodiments

The present application generally provides systems and methods that facilitate completion of repurchase agreements. Repurchase agreements (“repos”) are financial instruments where one party agrees to sell securities to another party while agreeing to repurchase the same securities back at a specified price and future date. Accordingly, repos perform essentially as secured loans, whereby the party that provides the money for the transaction receives securities as collateral in case of an event of default. Unlike loans, title passes between the parties in a repo transaction. The party that provides the money is often referred to as the buyer, or as executing a reverse repo. The party that receives the money in exchange for securities as collateral is often referred to as the seller, or as executing a repo.

Parties to a repo may agree on the date that the trade becomes effective. The date the trade becomes effective may be the date on which the funds, e.g., the money received for the securities, and the securities are exchanged. The parties may also agree on the date that the funds and securities are returned to the respective original parties. When the funds are returned to the buyer, the seller often pays interest to the buyer at a particular repo rate, e.g., the interest rate used for the repo. The rate at which interest is accrued is generally agreed upon at the time of the agreement. The repo rate can be influenced by the type and quality of collateral, as well as the specific counterparty. Typically, the higher the quality of the collateral the lower the repo rate. Also, the repo rate may be influenced by benchmark money market rates, such as LIBOR or the Fed Funds rate, general market depth and liquidity, the size of the transaction, counterparty credit, etc.

Repos may typically have short maturities. Nevertheless, repo maturities can range from one or more days, to one or more weeks, one or more months, one or more years, etc. In addition, one type of repo, an open repo, has an undefined maturity date and continues on a day-to-day basis whereby either party may end the agreement at any time. Repo rates may be fixed or floating based a broad range of indexes.

The repo market includes three basic types of transactions: repos, securities lending transactions, and buy/sell backs. Although these transactions have their own specific documentation, accounting and regulatory requirements, they are similar in nature and function. Underlying collateral in a repo transaction is generally priced at market value plus accrued interest to date. The price of securities is marked to market over the term of the trade, as necessary.

In order for a repo to be completed, the funds and corresponding securities exchange hands between, and return to, the buyer and the seller or the bank(s) with which the parties hold their respective accounts. A bank may act as a conduit to facilitate, settle, and hold securities in the repo transactions. The bank may hold and move the funds and securities to and from the buyer and seller accounts. If one party does not fulfill its obligations of delivering the funds or instruments under the agreement, the transaction may be said to have failed.

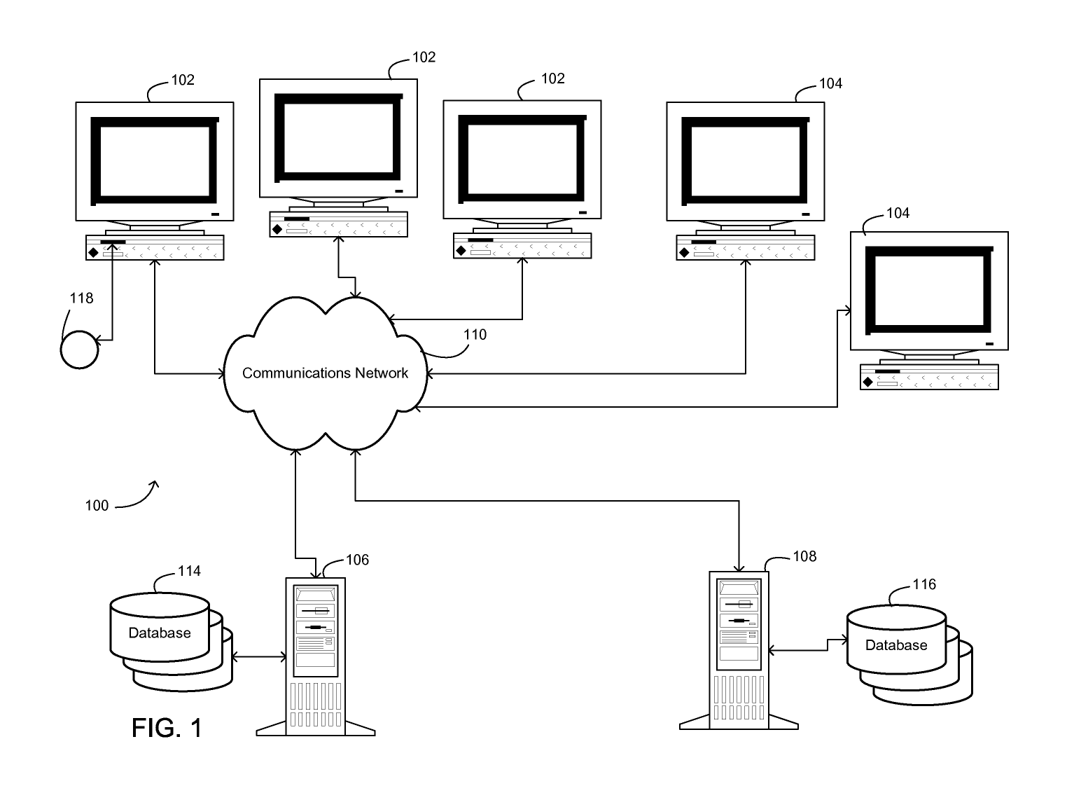

Referring to FIG. 1, a system 100, according to at least one embodiment of the systems disclosed herein, includes at least one computing device, such as a remote computer 106, e.g., a server computer, a client computer 102, or a combination thereof The term remote in this context merely means that the remote computer 106 and at least one of the client computers 102 are separate devices. Thus, the devices may be remote even if they are located within the same room. In at least one embodiment, the system includes at least one remote computer 106 that is connected over a communication network 110 to one or a plurality of client computers 102. One or more of the client computers 102 may be connected to the remote computer 106 through a firewall. In another embodiment, at least one remote computer 106 is connected over a communication network 110 to at least one other remote computer 108.

The system 100 may be implemented over any type of communications network 110, such as a local area network (LAN), a wide area network (WAN), the Internet, a telephone network (POTS), a wireless network, including cellular, WiFi, and WiMax networks, or a combination of wired and/or wireless networks. In certain instances, the communications network 110 may be independent of the Internet or limited with respect to the type of the information transmitted over the Internet, such as to information that poses little or no security risk if misappropriated or that has been encrypted.

In the networked embodiment, client computers 102 are preferably configured or otherwise capable of transmitting and/or receiving communications to and/or from the remote computer(s) 106, 108. The remote computers 106, 108 may similarly be configured or otherwise capable of transmitting and/or receiving communications between themselves. This may be accomplished with a communication element, such as a modem, an Ethernet interface, a transmitter/receiver, etc., that enables communication with a similarly equipped remote computer 106,108 wirelessly, wired, or a combination thereof. It is understood that the relative functionality described herein may be provided by the remote computers 106, 108, by the client computers 102, or both, and is thus not limited to any particular one of the implementations discussed herein. In at least one embodiment, the client computers 102 will generally provide the front-end functionality and the remote computer 106, 108 will provide the back-end functionality.

Although various embodiments may be described herein in relation to repurchase agreement type financial instruments, it is understood that the methods and systems disclosed herein are equally applicable to other types of financial instruments as well as non-financial instrument assets, such as commodities, money (in one or more currencies), goods, etc., and is thus not limited thereto. The term “financial instrument” denotes any instrument, issued by a corporation, government, or any other entity, that evinces dept or equity, and any derivative thereof, including equities, stocks, fixed income instruments, bonds, debentures, certificates of interest or deposit, warrants, options, futures, forwards, swaps, or generally any security.

The computing device, e.g., the client computers 102 and/or the remote computer 106, 108 generally include at least one processor, and a memory, such as ROM, RAM, FLASH, etc., including computer readable medium type memory, such as a hard drive, a flash-drive, an optical or magnetic disk, etc. The memory or computer readable medium preferably includes software stored thereon that when executed performs one or more steps of the methods disclosed herein, including communicating data and commands back and forth between the computers, displaying interface screens, etc. The computers may also be associated with or have access to one or more databases 114, 116 for retrieving and/or storing the various types of data discussed herein, including identity verification data, such as an ID and password, biometric data, etc., trade/order and market data, account data, account and market historic data, etc., e.g., for repos, reverse repos, etc., the underlying securities, and/or each of the parties to a repo transaction.

The relevant functionality and the data discussed herein may be provided/maintained by different entities. For example, the platform for repo creation and trading may be provided by a dealer or a group of dealers, an exchange or exchanges, private (OTC) or public, etc., or any other entity. The account information may be maintained by the same entity or entities providing the trading platform or by a separate entity or entities, such as a bank or a number of banks. Additionally, clearing services for the exchange of securities and money may be provided by a clearinghouse. As such, each or all of the client devices 102, 104, remote computers 106, 108, databases, 114, 116, etc., may be within the domain of one or more of entities.

The client computers 102 may include, without limitation, a mobile phone, PDA, pocket PC, personal computer, as well as any special or other general purpose computing device. As such, the client computer 102 preferably includes a processor, a memory, a display, such as a CRT or an LCD monitor, for displaying information and/or graphics associated with the functionality provided by the system 100, and at least one input device, such as a mouse, a touch-sensitive pad, a pointer, a stylus, a trackball, a button or a plurality of buttons, e.g., alphanumeric, a scroll wheel, a touch-sensitive monitor, etc., or a combination thereof, for users to enter commands and/or information relevant to the system's functionality. With the general purpose type of client computer 102, such as the PC or PDA, users may access the functionality provided by the system 100 with a browser application or any other generic application, or with special purpose software designed specifically for accessing the functionality disclosed herein.

In at least one embodiment, the client computer 102 includes or is otherwise associated with at least one biometric sensor 118. The biometric sensor 118 is any device that is used to determine directly from the user at least one item of biometric data associated with a user, such as a fingerprint reader, an iris scanner, a retinal scanner, a vascular pattern reader, a facial recognition camera, etc. The biometric sensor 118 may be embodied in hardware, software, or a combination thereof. The biometric sensor 118 may further share resources with other components of the client computer 102, such as the processor, memory, a camera, a microphone, a speaker, etc. A single biometric sensor 118 may be used for reading more than one type of biometric data. For example, a digital camera may be used to obtain an image of the user's eye for iris scanning and an image of the user's face for facial recognition. In this instance, a single image capture of the user's face may provide the data for facial recognition as well as data for iris or retinal comparisons.

The biometric data is generally obtained with the biometric sensor 118 and used at least to authenticate the identity of the user as a gateway for allowing the user to access the system's functionality. In this regard, biometric data may be compared with previously obtained/stored biometric data that has preferably been verified as being associated with a particular user and access to the system's functionality may be provided based on a positive match thereof.

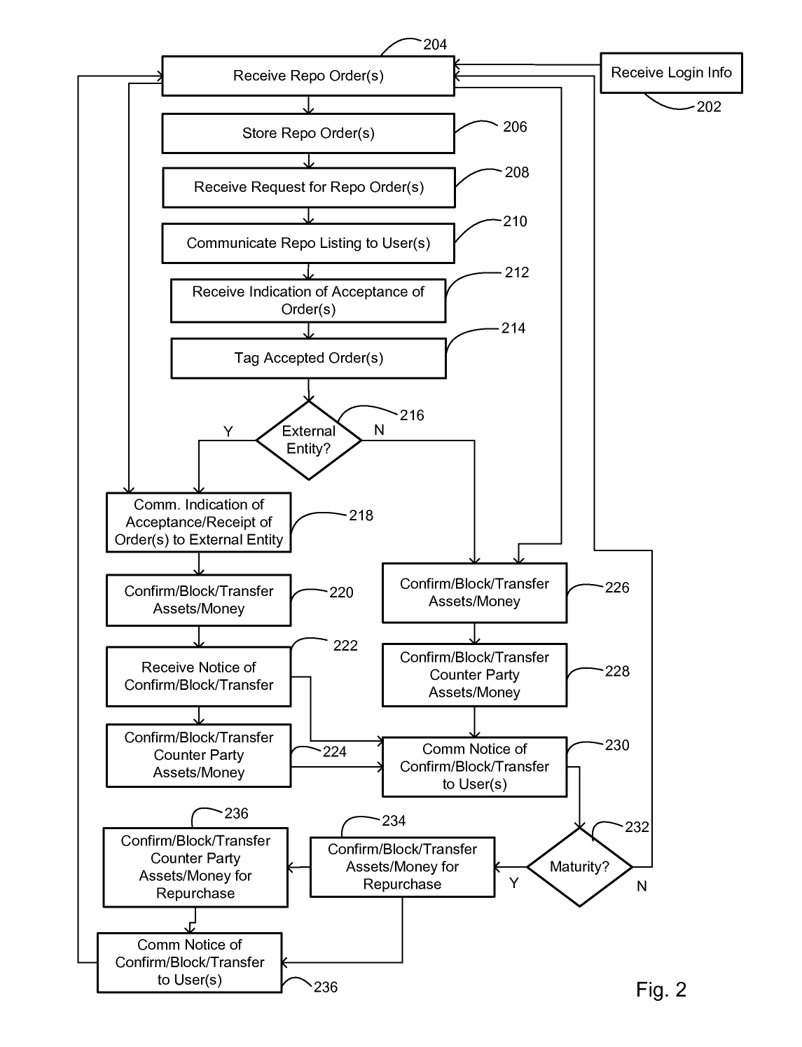

Referring to FIG. 2, a method 200 according to at least one embodiment of the methods disclosed herein begins with the system 100 receiving login information at 202. The login information may be any information for use in authenticating a user and providing thereto one or more of the functions disclosed herein. The login information may be, for example, a user ID, password, biometric data, etc. The login information may be submitted by a user with a user interface screen that includes therein at least one form element, such as an input field or text box, a drop down list, check box, radio buttons, action buttons, clickable images, etc., for entering login data. Following submission, the login information may be compared with previously obtained information and access to one or more of the functions may be provided based on a positive match.

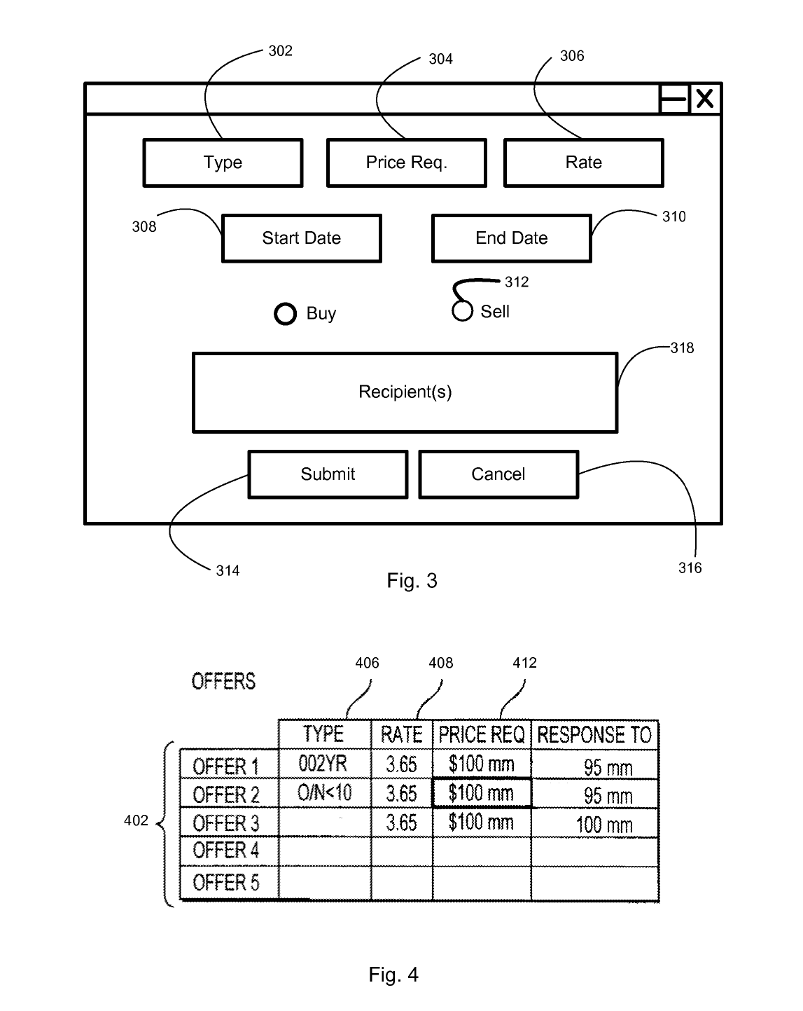

In at least one embodiment, the system 100 enables users to create/establish repos orders and communicate the repo orders to other users for action. A repo order may include offers to buy or sell, requests for quotes (RFQs), requests for bids (RFBs), indications of interest, a solicitation of a bid or offer, or generally any request to enter into a repo, etc. Thus, orders may be submitted by either a buyer or seller in a repo. This may be accomplished with a user interface, such as the user interface shown in FIG. 3, that includes therein at least one form element, such as an input field or text box, a drop down list, check box, radio buttons, action buttons, clickable images, etc., for a user to specify one or more terms of the repo order. The interface screen for specifying the terms of the repo order is preferably displayed in response to a user request for the interface screen.

The interface for specifying terms of an order may, for example, include a text box or drop down list, or other form element 302, for a user to specify the security or asset to be purchased or sold in accordance with the repo order. Preferably, the user may be allowed to specify specific assets or classes of assets. For example, a seller may specify or a buyer may require a specific 10 year bond or generally any 10 year bond. The interface may also include one or more form elements for a user to specify at least one of a price 304, a repo rate 306, a start date 308, and end date 310, whether the repo order will be submitted as an offer to sell or to purchase an asset 312, etc. The interface may further include at least one button for the user to submit the repo order for action 314 and/or a button for a user to cancel the repo order 316. The order may be submitted to the system 100 for action by any other system user or for action by specific users, e.g., identified by the party submitting the repo order, such as with form element 318. Once submitted, the repo order is received by the system at 204 and is preferably stored at 206, e.g., in at least one database, such as the database 114. Information regarding orders submitted by particular users may be logged in database having a record(s) representing a user's account. The user's account may therefore include information regarding pending orders, cancelled orders, accepted and/or executed orders, as well as information as to whether executed orders have matured.

Although the embodiments disclosed herein may refer to particular interface screens or to particular types of electronic communications, it is understood that information may be transmitted and/or communicated between the system and the system users in other, e.g., non-electronic/automated, ways. The present invention or inventions are therefore not limited to any particular interface screen and communication method.

In at least one embodiment, the system 100 may communicate repo orders at 210 to specific users or to any user requesting a listing of repo orders, e.g., that have not been acted on. Specific users may be targeted with one or more instant messages, e-mails, popup windows, facsimile transmissions, telephone calls, automated or otherwise, etc. For other users, a listing of pending repo orders may be communicated to a user in response to receiving a request for such data at 208 from one or more users. The listing may be displayed in an interface screen, such as the screen shown in FIG. 4, which includes one or more repo orders displayed therein. The request may be a general query in response to which the system 100 communicates to the requesting user a listing of all pending orders or a specific query in response to which the system 100 communicates to the requesting user a listing of orders that satisfy the specific query, e.g., for specific asset types, price or price range, interest rate or range of rates, repo start and/or end dates, repo duration, etc.

As can bee seen in FIG. 4, the listing of repo orders may include the terms of the repo orders 402, such as the type of asset being sold 406, the repo rate 408, the price required 412, etc., as well as other data relevant to the orders being displayed, such as response data for each order. Type 406 generally indicates whether a specific asset or kind of asset was requested as collateral, whether an asset was requested that meets a criteria, e.g., an asset that matures in less than ten years, an asset that meets a certain rating, etc., or whether the request was a general request for any collateral. For example, for the offer labeled Offer 1, the item to be sold is specified as 002YR. For the offer labeled Offer 2, specific collateral was not specified. Rather, the collateral requested is an overnight transaction for assets, e.g., bonds, which mature in less than 10 years. For Offer 3, no specific collateral and no general criteria were specified. As shown, the rate and price requested for each offer 402 are the same at 3.65 and $100 million, respectively.

In at least one embodiment, the system 100 may enable users to act on any of the orders communicated thereto, in which instance, the system 100 may receive an indication that a user is acting on an order at 212. The indication may be any communication from a user indicating that the user is, e.g., accepting an offer, submitting a counter offer, etc. For example, a user may accept an offer by indicating as such in an instant message or email in response to the targeted offer. The targeted party may similarly submit a counter offer in a response to the targeted instant message, email, etc., which may be accepted or countered by the originating party. The system 100 may also allow the user to accept an order or submit a counter offer to an order displayed in the repo listing. For example, a user may choose to lift one or more of the offers 402 by double-clicking on an offer with a pointer or a cursor placed over the offer or any portion thereof in the interface screen with the listing using the input device. A confirmation dialog box may be displayed in response to a user selecting an offer on the interface screen, witch prompts the user to confirm the action being taken, e.g., to confirm acceptance, the counter offer, etc.

Orders accepted or otherwise acted on may be tagged at 214, e.g., in a field associated with a record of an accepted order in the one or more databases 114, 116, a flag or tag in a, e.g., HTML or XML document, etc. Tagged orders may be filtered accordingly prior to communicating order lists to one or more users. For example, tagged orders may be filtered from requests for a list of pending orders or may be included in a list of accepted orders.

As noted above, the parties to a repo may agree on, among other things, the type of securities or other asset that are acceptable, the date that the funds and securities or other assets are to be transferred in the first instance, e.g., at the start date, and returned to the respective original parties, e.g., at the end date, and the repo rate paid to the buyer. In order for a repo to be completed, the money and corresponding assets exchange hands in a purchase portion of the repurchase agreement between the buyer and the seller and again at the end of the repo. In this respect, the repo transaction may implicate one or more banks or other entities with which the parties hold their respective accounts. For example, each party may have an account with its own bank or the parties may have accounts with the same bank. Three scenarios are generally implicated: both parties to the repo have an account with a single entity that also provides the platform for trading repos as discussed herein; one of the parties to the repo has an account with the entity that provides the repo trading platform and the other has an account with an external entity, e.g., an entity other than the trading platform provider; and both parties have accounts with at least one entity external from the entity that provides the trading platform. Moreover, at least one bank or other entity may act as a conduit to facilitate, settle, and/or hold securities in the repo transactions. The intermediary may hold and move the funds and securities to and from the buyer and seller accounts as discussed herein.

A determination may be made at 216 as to whether an external entity is implicated or is necessary to complete at least a portion of the repo transaction. That is, a determination may be made as to whether the assets and/or the money for the repo transaction are held in accounts with different entities, or with the same entity that is not the entity providing the trading platform. This may be accomplished with a user profile or record that includes therein information regarding the accounts that hold the particular assets and/or money for the repo transaction, including information regarding the particular entities with which the accounts are kept. Alternatively or additionally, the particular assets may be assigned to the repo transaction either manually, automatically, or a combination thereof, in the manner discussed in U.S. patent application Ser. No. 10/127,226.

When an external entity is implicated at 216, system 100 may at 218 communicate an indication of an accepted order to the respective entities with which the parties to an accepted order have an account or accounts with the assets for the repo transaction. The indication preferably includes information therein, such as data for identifying the source and/or target account or accounts (account numbers), the assets involved (name, particular lot(s), etc.), the quantity of the assets and/or money, etc. The external entity may determine at 220 whether the particular assets and/or the amount of money for the repo exist, block the assets/money, and/or transfer the assets/money out of the source account and into the target account to satisfy the purchase portion of the repo.

The manner in which the external entity responds to the indication of an accepted order may be defined in the indication, predefined by the parties to the repo or the entity providing the trading platform, etc., or a combination thereof. For example, the indication of an accepted offer transmitted to the external entity holding the seller's/buyer's account may direct the external entity to either confirm that the account includes the specified assets/money, to block any future transactions with regard to the specified assets/money, and/or transfer the specified assets/money to the buyer's/seller's or a specified account, respectively. The instructions may similarly be stored in a database or file, either with the external entity and/or with the platform provider for such use for all parties or for specific parties.

The external entity may communicate and the system 100 may receive information at 222 indicating that, e.g., the particular assets or money for the repo transaction exist, have been blocked and/or transferred for at least one of the parties to the repo. The system 100 may similarly determine whether the particular assets or the amount of money for satisfying the repo exist, block the assets/money, and/or transfer the assets/money between accounts at 228 for at least one of the parties to the repo in instances when external entities are not implicated at 216. In one embodiment, the system 100 confirms and/or blocks the assets/money in response to a user submitting the repo order, either alone or in combination with the external entity. In this instance, the external entity and/or the system 100 may confirm, block, and/or transfer the assets/money in a plurality of stages. That is, the contents of an account may be confirmed and/or blocked at a first time, e.g., at the submission of an order, and the transfer to satisfy the purchase portion of the repo may occur at a second later time, e.g., at the acceptance of an offer. This may provide assurance of the existence of the assets/money for users acting on an order.

In at least one embodiment, the system 100 provides at 230 a notification to one or more of the parties (or to a user prior to acceptance) that the securities, money, or any other of the assets for satisfying the purchase portion of the repo are in a predetermined account, have been blocked, and/or transferred, etc., in response to a request for such information or automatically, so that, e.g., the money and/or the corresponding counter side securities or other assets for satisfying the purchase portion of the repo may be blocked, released, and/or transferred to the respective other party at 224, 228. Notification may be in any form, including an instant message, email, a pop-up window, or some indication on an interface screen that provides the status of one or more repo orders, accepted or otherwise. For example, a notification that securities or any other assets exist, have been blocked, and/or have been placed or transferred into a particular account may be in the form of a visual indicator displayed on the workstation or client device interface screen. The visual indicator may be text indicating the transfer status of an order displayed with the listing, highlighting, color coding, etc.

Notification that not all of the assets necessary to satisfy the repo order exist and/or have been blocked may also be provided. In this instance, a potential buyer or seller may be notified through the user workstation or client device that a portion (and not all) of the assets/money required exist, has been blocked, or placed in a bank account. In such a situation, the buyer or seller may enter a command to transfer a portion of the respective funds or assets that corresponds to the portion of the assets/money that exist, has been blocked, or transferred to the account. Alternatively or in addition, the partial transfer may occur automatically. The counter side assets/money may be blocked, released, and/or transferred, as the case may be, manually, e.g., following notification to and upon request from the counter side party, automatically, or a combination thereof, at 224, 228. Notification may also be provided that the assets and/or the money have been unblocked. The assets/money may be unblocked, in certain instances, on direction of either party, upon a change in the order requiring fewer assets and/or less money, etc.

Alternatively or in addition, the return of the securities or other assets, and/or the money to satisfy the repurchase portion of the repo may be blocked or restricted until the corresponding money and/or securities or other assets are returned at the end date at 234, 236. That is, repurchase may be handled similarly at the maturity of the repo as at the submission of the repo order and/or acceptance thereof. For example, at the end date, the confirmation, blocking, and transfer may be initiated with regard to the assets and/or the money to be retransferred to complete the repurchase portion of the repo. In one embodiment, the external entity and/or the system 100 confirm and block the contents of an account for the repurchase, e.g., at the end date, and transfer the assets/money at a later time, e.g., upon confirmation from a counter party and/or automatically. Notification may be provided at 238 to either party at the end date of the transaction to indicate that the assets exist in a particular account, have been blocked or released, as the case may be, and/or transferred back to the respective party. This may similarly provide assurance of the existence of the assets/money for parties completing the repo.

Accordingly, by ensuring the existence of an asset and/or money prior to delivery of the money and/or assets, respectively, prior to acceptance, on or about the start date, and/or on or about the end date, transaction failure may be successfully avoided or otherwise ameliorated. The state of an order following acceptance may be maintained with tags or fields as discussed above. For example, a field in a database record associated with an order may include status information to indicate that the order has been accepted, assets confirmed, blocked, released, transferred, matured, etc.

Therefore, the bank or the trading system through which the bank and parties communicate, may notify the buyer that the assets the buyer is seeking exist, have been blocked, and/or have been deposited, e.g., in a holding account, so that, e.g., the buyer may authorize the release of money to the seller for the purchase of the assets. The notification to potential buyers may be provided in response to a request to enter into the repo, e.g., the repo order, and/or an inquiry as to whether the securities have been deposited. The authorization to release funds may be derived from the acceptance by the buyer of the repo order or upon request at a later time. The account into which the security exists or may be placed may be determined from an order or from the acceptance of the order. For example, the buyer and the seller may include information therein identifying the buyer/seller or his or her bank account(s). Moreover, the seller may be notified of the release of funds on or about the start date.

When the agreement reaches maturity, the seller may be notified that the securities have been confirmed, blocked, and/or released back to him or her so that he or she may authorize the release of funds as a repayment under the terms of the repo to the buyer. Alternatively, the seller may have to repay the funds with interest, at which point, the buyer may be notified that the funds with the interest have exist, are blocked, and/or have been transferred so as to release the securities back to the seller. Notification may be provided upon request by the concerned party or automatically upon receipt of securities or money by the bank.

Restrictions may be imposed on the account in which the securities may be placed. For example, the account may be a predetermined bank account, which may be a numbered account, that blocks the return of the security until the corresponding funds are returned to it, to another account or until authorized by the account owner. Alternatively, the bank account may be less restrictive and may instead allow limited transferability of the securities therein.

The assets for the repo can be U.S. Government and agency securities, emerging markets bonds, asset-backed loans, various money market instrument, commercial paper, notes, foreign bonds, etc. The buyer may require specific collateral (a particular type of security) or general collateral (any instrument that satisfies certain criteria). In a situation where the buyer requires a particular type of security, the collateral placed in the bank account may not be transferred or substituted before maturity unless replaced by issue of the same instrument or if otherwise allowed by the buyer. Alternatively, if the buyer accepts general collateral under specific criteria, the seller may exchange the securities in the bank account before maturity provided they are replaced with securities that meet these criteria. The buyer may require such replacement to occur prior to the removal of the original collateral placed in the account.

In another embodiment, a potential participant may not be allowed to become a seller in a repurchase agreement unless or until he or she places securities in the bank account or indicates in another suitable manner that he or she is willing to pledge such securities as collateral.

The methods disclosed herein may be implemented in an electronic trading system in which repos, and other agreements, transactions or instruments, may be entered into and traded. A system for implementing at least one of the methods of the present application may include one or more local or remote user workstations that are connected to a computer network that is linked to a server that processes the transactions and that is coupled to a back office center that clears the transactions.

One of ordinary skill in the art should appreciate that the methods and systems of the present application may be practiced in embodiments other than those described herein. For example, repos may be offered in different pools. Different repo rates or prices may be offered to different repo pools. Embodiments discussed or shown herein may be applied to repo agreements or any other suitable agreements, transactions, exchanges and/or sales.

It will be understood that the foregoing is only illustrative of the principles disclosed herein, and that various modifications can be made by those skilled in the art without departing from the scope and spirit of the invention or inventions disclosed herein.

What is claimed is:

1. A system comprising at least one computing device having a processor and a memory with software stored thereon that when executed enables the computing device to perform a method comprising:
receiving at least one order for a repurchase agreement involving an asset;
determining in response to the at least one order an existence of at least one of the asset and money to satisfy at least a purchase portion of the repurchase agreement; and
communicating a notification of the existence of the at least one of the asset and money.

2. The system of claim 1, the method comprising blocking the at least one of the assets and the money to satisfy the at least a purchase portion of the repurchase agreement.

3. The system of claim 2, wherein communicating the notification comprises causing an interface screen to be displayed with an indication therein that the at least one of the assets and money have been blocked.

4. The system of claim 1, wherein communicating the notification comprises causing an interface screen to be displayed with an indication therein confirming the existence of the at least one of the assets and money.

5. The system of claim 1, the method comprising receiving an acceptance of the at least one order and transferring the at least one of the assets and money from a first account into a second account.

6. The system of claim 1, the method comprising communicating a notification that the at least one of the assets and money have been transferred to a predetermined account.

7. The system of claim 1, the method comprising communicating a listing comprising the at least one order for the repurchase agreement and receiving an acceptance of the at least one order with a selection of the at least one order in the listing.

8. The system of claim 7, the method comprising transferring at least one of the assets and money from an account associated with a first party to the repurchase agreement into an account associated with a second party to the repurchase agreement in response to the acceptance of the at least one order.

9. The system of claim 8, the method comprising confirming an existence of at least one of counter party money and assets, respectively, to satisfy at least a portion of the purchase portion of the repurchase agreement prior to the transfer of the at least one of the assets and money.

10. The system of claim 9, the method comprising transferring the at least one of the counter party money and assets from the second party account into the first party account in response to the acceptance of the at least one order.

11. The system of claim 10, the method comprising confirming an existence of at least one of assets and money to satisfy a repurchase portion of the repurchase agreement.

12. The system of claim 11, the method comprising blocking the at least one of the assets and money to satisfy the repurchase portion of the repurchase agreement.

13. The system of claim 11, the method comprising transferring the at least one of the assets and money to satisfy the repurchase portion of the repurchase agreement from the first party account into the second account.

14. A system comprising at least one computing device having a processor and a memory with software stored thereon that when executed enables the computing device to perform a method comprising:
receiving at least one order for a repurchase agreement involving an asset;
determining in response to the at least one order an existence of at least one of the asset and money to satisfy at least a purchase portion of the repurchase agreement;
blocking the at least one of the assets and the money to satisfy the at least a purchase portion of the repurchase agreement; and
causing an interface screen to be displayed with an indication therein that the at least one of the assets and money have been blocked.

15. A method comprising:
receiving at least one order for a repurchase agreement involving an asset;
determining in response to the at least one order an existence of at least one of the asset and money to satisfy at least a purchase portion of the repurchase agreement; and
communicating a notification of the existence of the at least one of the asset and money.

16. The method of claim 15, comprising blocking the at least one of the assets and the money to satisfy the at least a purchase portion of the repurchase agreement.

17. The method of claim 16, wherein communicating the notification comprises causing an interface screen to be displayed with an indication therein that the at least one of the assets and money have been blocked.

18. The method of claim 15, wherein communicating the notification comprises causing an interface screen to be displayed with an indication therein confirming the existence of the at least one of the assets and money.

19. The method of claim 15, comprising receiving an acceptance of the at least one order and transferring the at least one of the assets and money from a first account into a second account.

20. The method of claim 15, comprising communicating a notification that the at least one of the assets and money have been transferred to a predetermined account.

21. The method of claim 15, comprising communicating a listing comprising the at least one order for the repurchase agreement and receiving an acceptance of the at least one order with a selection of the at least one order in the listing.

22. The method of claim 21, comprising transferring at least one of the assets and money from an account associated with a first party to the repurchase agreement into an account associated with a second party to the repurchase agreement in response to the acceptance of the at least one order.

23. The method of claim 22, comprising confirming an existence of at least one of counter party money and assets, respectively, to satisfy at least a portion of the purchase portion of the repurchase agreement prior to the transfer of the at least one of the assets and money.

24. The method of claim 23, comprising transferring the at least one of the counter party money and assets from the second party account into the first party account in response to the acceptance of the at least one order.

25. The method of claim 24, comprising confirming an existence of at least one of assets and money to satisfy a repurchase portion of the repurchase agreement.

26. The method of claim 25, comprising blocking the at least one of the assets and money to satisfy the repurchase portion of the repurchase agreement.

27. The method of claim 25, comprising transferring the at least one of the assets and money to satisfy the repurchase portion of the repurchase agreement from the first party account into the second account.

28. A method comprising:
receiving at least one order for a repurchase agreement involving an asset;
determining in response to the at least one order an existence of at least one of the asset and money to satisfy at least a purchase portion of the repurchase agreement;
blocking the at least one of the assets and the money to satisfy the at least a purchase portion of the repurchase agreement; and
causing an interface screen to be displayed with an indication therein that the at least one of the assets and money have been blocked.
